(19) United States
(12) Patent Application Publication
(10) Pub. No.: US 2022/0366271 A1
(43) Pub. Date: Nov. 17, 2022

(54) LEARNING DATA GENERATION DEVICE, LEARNING DEVICE, LEARNING DATA GENERATION METHOD, AND LEARNING DATA GENERATION PROGRAM

(71) Applicant: NIPPON TELEGRAPH AND TELEPHONE CORPORATION, Tokyo (JP)

(72) Inventors: Yuki KURAUCHI, Tokyo (JP); Naoto ABE, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/620,055

(22) PCT Filed: Jun. 19, 2019
(86) PCT No.: PCT/JP2019/024326

§ 371 Date: Dec. 16, 2021

(51) Int. Cl. G06N 5/02

(52) U.S. Cl. CPC G06N 5/022

(57) ABSTRACT

To make it possible to generate, at low cost, learning data for accurately estimating a state.

A first learning unit 103 learns a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given. A generation unit 106 generates, based on a set of second learning data and the learned generation model, a set of third learning data to which the first correct answer label and the second correct answer label about conditions other than the predetermined condition are given, the second learning data being learning data which is collected under a predetermined condition among the plurality of conditions and to which the second correct answer label is given.

### TECHNICAL FIELD

The present disclosure relates to a learning data generation device, a learning device, a learning data generation method, and a learning data generation program.

### BACKGROUND ART

A technique for estimating, using measured data, whether certain conditions are satisfied has been studied. For example, a method of estimating, using a sensor mounted on a mobile body such as a pedestrian, an automobile, or a wheelchair moving on a road surface of a sidewalk, a driveway, or the like, a state (for example, a level difference or a gradient) of the road surface on which the mobile body moves has been studied (Non-Patent Literature 1 and Non-Patent Literature 2).

### CITATION LIST

### Non-Patent Literature

Non-Patent Literature 1: Akihiro Miyata, Iori Araki, Tongshun Wang, Tenshi Suzuki, “A Study on Barrier Detection Using Sensor Data of Unimpaired Walkers” IPSJ Journal (2018).
Non-Patent Literature 2: “Unevenness of a Road Surface was Detected by an Acceleration Sensor of a Smartphone Placed on a Highway Bus and a Verification Test was Carried out”, [online], [searched on Sep. 4, 2018], Internet <URL: https://sgforum.impress.co.jp/news/3595>.

### SUMMARY OF THE INVENTION

### Technical Problem

The above estimation is performed using, for example, an estimation model constructed by learning using learning data. However, in the conventional method, there is a problem in that accuracy of estimation is insufficient and a lot of learning data are necessary. Accordingly, there is a problem in that, whereas cost for collecting a lot of learning data increases, a state to be estimated cannot be estimated with sufficient accuracy.

The technique of the disclosure has been made in view of the above points, and an object of the technique of the disclosure is to provide a learning data generation device, learning data generation method, and a learning data generation program that can generate, at low cost, learning data for accurately estimating a state.

An object of the technique of the disclosure is to provide a learning device that can learn an estimation model for accurately estimating a state.

### Means for Solving the Problem

A first aspect of the present disclosure is a learning data generation device including: a first learning unit that learns a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and a generation unit that generates, based on a set of second learning data and the generation model learned by the first learning unit, a set of third learning data to which the first correct answer label and the second correct answer label about conditions other than the predetermined condition are given, the second learning data being learning data which is collected under a predetermined condition among the plurality of conditions and to which the second correct answer label is given.

A second aspect of the present disclosure is a learning data generation method including: a first learning unit learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and a generation unit generating, based on a set of second learning data and the generation model learned by the first learning unit, a set of third learning data to which the first correct answer label and the second correct answer label about conditions other than the predetermined condition are given, the second learning data being learning data which is collected under a predetermined condition among the plurality of conditions and to which the second correct answer label is given.

A third aspect of the present disclosure is a learning data generation program for causing a computer to execute: a first learning unit learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and a generation unit generating, based on a set of second learning data and the generation model learned by the first learning unit, a set of third learning data to which the first correct answer label and the second correct answer label about conditions other than the predetermined condition are given, the second learning data being learning data which is collected under a predetermined condition among the plurality of conditions and to which the second correct answer label is given.

A fourth aspect of the present disclosure is a learning device including a second learning unit that learns, based on the set of the second learning data and the set of the third learning data generated by the learning data generation device described in claim 1, about input data, estimation model for estimating the predetermined state.

### Effects of the Invention

According to the technique of the disclosure, it is possible to generate, at low cost, learning data for accurately estimating a state.

According to the technique of the disclosure, it is possible to learn an estimation model for accurately estimating a state.

### BRIEF DESCRIPTION OF DRAWINGS

FIG. 1 is a block diagram showing a schematic configuration of a computer functioning as a learning data generation device (a learning device) according to an embodiment.

FIG. 2 is a block diagram showing an example of functional configurations of the learning data generation device and the learning device according to the embodiment.

FIG. 3 is an image diagram representing a state in which, from smooth road surface data, road surface data of a rough road surface and road surface data in other conditions are generated.

FIG. 4 is a flowchart showing a learning data generation processing routine of the learning data generation device according to the embodiment.

FIG. 5 is a flowchart showing a learning processing routine of the learning device according to the embodiment.

### DESCRIPTION OF EMBODIMENTS

<Overview of a Learning Data Generation Device and a Learning Device According to an Embodiment of the Technique of the Present Disclosure>

First, an overview of an embodiment of a technique of the present disclosure is explained. First, a learning data generation device according to this embodiment prepares a set of first learning data to which a first correct answer label, which is a label indicating a correct answer about any one of a plurality of conditions, and a second correct answer label, which is a correct answer label indicating a predetermined state, are given. That is, the learning data generation device prepares learning data that is, about each of the plurality of conditions, known to satisfy the condition and is known about the predetermined state. The learning data generation device learns, using the set of the first learning data, a generation model for outputting, when data to which the second correct answer label is given is input, data to which the first correct answer label indicating any one of the plurality of conditions is given. By using the learned generation model, it is possible to generate learning data that satisfies a condition corresponding to the first correct answer label among the plurality of conditions.

Subsequently, the learning data generation device generates, based on a set of second learning data, which is data to which a first correct answer label and a second correct answer label about a predetermined condition among a plurality of conditions are given, and a generation model learned by a first learning unit, a set of third learning data to which a first correct answer label and a second correct answer label about conditions other than the predetermined condition are given. The second learning data means general learning data obtained under a predetermined condition that is easily corrected. The third learning data means learning data satisfying the conditions other than the predetermined condition and learning data to which a correct answer label of the conditions other than the predetermined condition is given.

In this way, with the learning data generation device according to this embodiment, even when the first learning data is little, by using the learned generation model, it is possible to generate, in a large amount, the third learning data satisfying various conditions from the set of the second learning data, which is general learning data that can be collected at low cost.

A learning device according to this embodiment learns, based on the set of the second learning data and the set of the third learning data generated by the learning data generation device, about input data, an estimation model for estimating a predetermined state. Since the set of the second learning data collected at low cost and the third learning data by various conditions generated in a large amount can be used in this way, it is possible to learn an estimation model that can accurately perform estimation.

<Configuration of the Learning Data Generation Device According to the Embodiment of the Technique of the Present Disclosure>

An example of the embodiment of the technique of the disclosure is explained below with reference to the drawings. In this embodiment, a case in which an estimation model for estimating a state of a barrier of road surface data measured by a sensor mounted on a mobile body running on a road surface is learned is explained as an example. In this embodiment, the barrier is explained as being a condition that is hindrance of running such as a level difference or an inclination of a road surface. Learning data necessary for learning the estimation model is road surface data to which a correct answer label indicating a state of the road surface is given. A learning data generation device 10 of the present disclosure generates such learning data. Note that the same or equivalent components and portions are denoted by the same reference numerals and signs in the drawings. Dimension ratios of the drawings are exaggerated for convenience of explanation and are sometimes different from actual ratios.

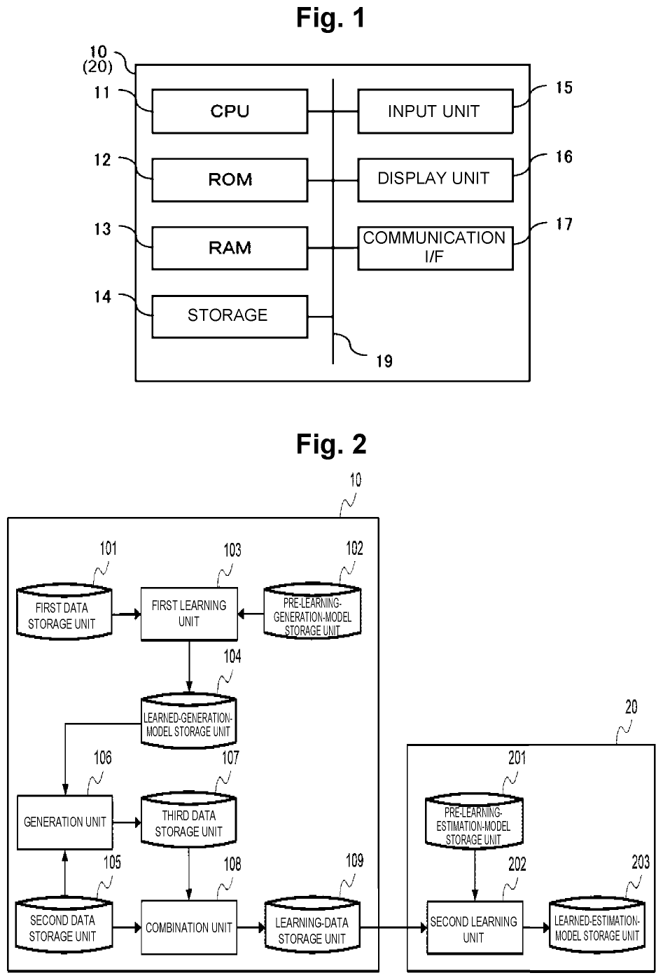

FIG. 1 is a block diagram showing a hardware configuration of the learning data generation device 10 according to this embodiment. As shown in FIG. 1, the learning data generation device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The components are communicably connected to one another via a bus 19.

The CPU 11 is a central arithmetic processing unit and executes various programs and controls the units. That is, the CPU 11 reads out the programs from the ROM 12 or the storage 14 and executes the programs using the RAM 13 as a work area. The CPU 11 performs control of the components and various kinds of arithmetic processing according to the programs stored in the ROM 12 or the storage 14. In this embodiment, a learning data generation program for executing learning data generation processing is stored in the ROM 12 or the storage 14.

The ROM 12 stores various programs and various data. The RAM 13 functions as a work area and temporarily stores programs or data. The storage 14 is configured by a HDD (Hard Disk Drive) or an SSD (Solid State Drive) and stores various programs including an operating system and various data.

The input unit 15 includes a pointing device such as a mouse and a keyboard and is used to perform various inputs.

The display unit 16 is, for example, a liquid crystal display and displays various kinds of information. The display unit 16 may adopt a touch panel type and function as the input unit 15.

The communication interface 17 is an interface for communicating with other apparatuses. A standard such as Ethernet (registered trademark), FDDI, or Wi-Fi (registered trademark) is used as the communication interface 17.

Subsequently, functional components of the learning data generation device 10 are explained. FIG. 2 is a block diagram showing an example of the functional components of the learning data generation device 10.

As shown in FIG. 2, the learning data generation device 10 includes, as the functional components, a first data storage unit 101, a pre-learning-generation-model storage unit 102, a first learning unit 103, a learned-generation-model storage unit 104, a second data storage unit 105, a generation unit 106, a third data storage unit 107, a combination unit 108, and a learning-data storage unit 109. The functional components are realized by the CPU 11 reading out the learning data generation program stored in the ROM 12 or the storage 14, developing the learning data generation program in the RAM 13, and executing the learning data generation program.

In the first data storage unit 101, a set of first learning data to which a first correct answer label, which is a label indicating a correct answer about any one of a plurality of conditions, and a second correct answer label, which is a correct answer label indicating a predetermined state, are given is stored.

Specifically, the first learning data is collected by measuring road surface data indicating a state of a road surface measured by a sensor mounted on a mobile body running on the road surface. A first correct answer label indicating any one of a plurality of conditions about a road surface environment in the measurement is given to the first learning data. As the plurality of conditions, such conditions are adopted that, for example, the measurement is conducted on a smooth road surface, the measurement is conducted on a rough road surface, the measurement is conducted in a mobile body having tires with determined cushion properties, and the measurement is conducted in a state in which a location of a sensor set on the mobile body is decided. A second correct answer label, which is a correct answer label indicating what kind of a barrier a road surface in a measured section is, is given to the first learning data.

In the pre-learning-generation-model storage unit 102, a generation model for, when data to which the second correct answer label is given is input, outputting data to which the first correct answer label indicating any one of the plurality of conditions is given is stored in a state before learning, that is, a state in which parameters are initial values. The generation model can adopt any neural network. For example, the generation model can adopt an autoencoder.

The first learning unit 103 learns the generation model based on the set of the first learning data. Specifically, first, the first learning unit 103 acquires the set of the first learning data from the first data storage unit 101. The first learning unit 103 acquires the generation model and the initial parameters from the pre-learning-generation-model storage unit 102. Subsequently, the first learning unit 103 learns, based on the set of the first learning data, the parameters of the generation model such that the generation model calculates a likelihood for each first correct answer label indicating each of the plurality of conditions with respect to the data to which the second correct answer label is given. The first learning unit 103 learns the parameters of the generation model not to affect the second correct answer label of the input data. The first learning unit 103 performs the learning of the parameters using, for example, backpropagation. The first learning unit 103 repeats the learning of the parameters until an end condition is satisfied. Note that, in second and subsequent learning, the first learning unit 103 uses parameters learned last time by the first learning unit 103 rather than the initial parameters. The first learning unit 103 stores the learned generation model and the parameters in the learned-generation-model storage unit 104.

The generation model and the parameters learned by the first learning unit 103 are stored in the learned-generation-model storage unit 104.

In the second data storage unit 105, a set of second learning data, which is collected under a predetermined condition among the plurality of conditions and to which the second correct answer label is given, is stored. In this embodiment, the predetermined condition is that the learning data is measured on a smooth road surface, which is a general condition. This is because, in the case of the general condition, the learning data is easily collected at low cost. That is, the predetermined condition may be any condition in which the learning data is easily collected at low cost. A second correct answer label, which is a correct answer label indicating what kind of a barrier a road surface is, is given to the second learning data. That is, a correct answer label of a state desired to be estimated is given to the second learning data.

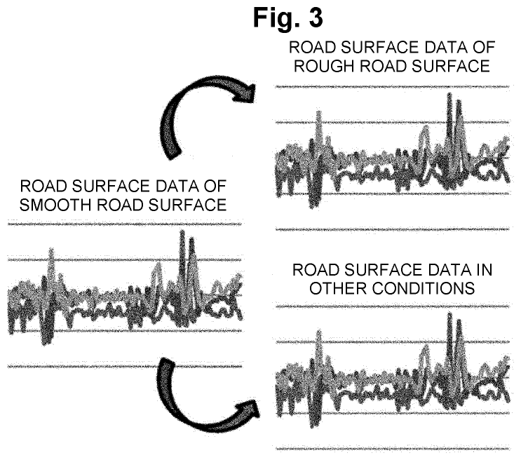

The generation unit 106 generates, based on the set of the second learning data and the generation model learned by the first learning unit 103, a set of third learning data to which the first correct answer label and the second correct answer label about conditions other than the predetermined condition are given. Specifically, first, the generation unit 106 acquires the set of the second learning data from the second data storage unit 105. The generation unit 106 acquires the learned generation model and the parameters from the learned-generation-model storage unit 104. Subsequently, the generation unit 106 generates, about each of the conditions other than the predetermined condition among the plurality of conditions, using the learned generation model, the third learning data obtained by giving the first correct answer label of the condition to the second learning data. That is, as shown in FIG. 3, the generation unit 106 generates road surface data of a rough road surface and road surface data in other conditions from smooth road surface data. Consequently, a large amount of the third learning data in a special condition can be generated from a large amount of the second learning data in the general condition and a small amount of the first learning data in a special condition. The generation unit 106 stores the generated set of the third learning data in the third data storage unit 107.

In the third data storage unit 107, the set of the third learning data generated by the generation unit 106 is stored.

The combination unit 108 combines the set of the second learning data and the set of the third learning data into a set of combined learning data. Specifically, first, the combination unit 108 acquires the set of the second learning data from the second data storage unit 105 and acquires the set of the third learning data from the third data storage unit 107. Subsequently, the combination unit 108 combines the set of the second learning data and the set of the third learning data such that learning by a learning device 20 is easily performed. For example, the combination unit 108 combines the set of the second learning data and the set of the third learning data with a method of, for example, attaching indexes or rearranging the learning data at random. The combination unit 108 stores a set of combined learning data in the learning-data storage unit 109.

In the learning-data storage unit 109, the set of the combined learning data combined by the combination unit 108 is stored.

<Action of the Learning Data Generation Device According to the Embodiment of the Technique of the Present Disclosure>

Subsequently, action of the learning data generation device 10 is explained.

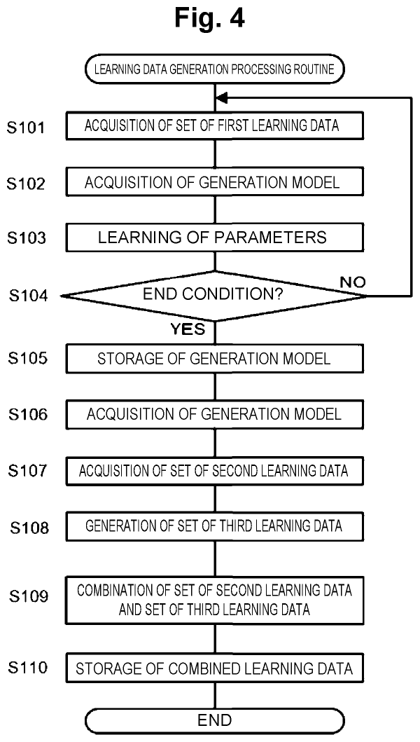

FIG. 4 is a flowchart showing a flow of a learning data generation processing routine by the learning data generation device 10. The CPU 11 reads out the learning data generation program from the ROM 12 or the storage 14, develops the learning data generation program in the RAM 13, and executes the learning data generation program, whereby the learning data generation processing routine is performed.

In step S101, the CPU 11 functions as the first learning unit 103 and acquires the set of the first learning data from the first data storage unit 101 to which the first correct answer label, which is a label indicating a correct answer about any one of a plurality of conditions, and the second correct answer label, which is a correct answer label indicating a predetermined state, are given.

In step S102, the CPU 11 functions as the first learning unit 103 and, when data to which the second correct answer label is given is input from the pre-learning-generation-model storage unit 102, acquires the generation model for outputting data to which the first correct answer label indicating any one of the plurality of conditions is given and the initial parameters.

In step S103, the CPU 11 functions as the first learning unit 103 and learns, based on the set of the first learning data, the parameters of the generation model such that the generation model calculates a likelihood of the first correct answer label of the first learning data indicating each of the plurality of conditions with respect to the data to which the second correct answer label is given.

In step S104, the CPU 11 functions as the first learning unit 103 and determines whether the end condition is satisfied.

When the end condition is not satisfied (NO in step S104), the CPU 11 returns to step S101.

On the other hand, when the end condition is satisfied (YES in step S104), in step S105, the CPU 11 functions as the first learning unit 103 and stores the learned generation model and the learned parameters in the learned-generation-model storage unit 104.

In step S106, the CPU 11 functions as the generation unit 106 and acquires, from the learned-generation-model storage unit 104, the generation model and the parameters learned in step S103.

In step S107, the CPU 11 functions as the generation unit 106 and acquires the set of the second learning data from the second data storage unit 105.

In step S108, the CPU 11 functions as the generation unit 106 and generates, based on the set of the second learning data and the generation model learned in step S103, the set of the third learning data to which the first correct answer label and the second correct answer label about the conditions other than the predetermined condition are given.

In step S109, the CPU 11 functions as the combination unit 108 and combines the set of the second learning data and the set of the third learning data into a set of combined learning data.

In step S110, the CPU 11 functions as the combination unit 108 and stores the set of the combined learning data in the learning-data storage unit 109 and ends the processing.

As explained above, the learning data generation device according to the embodiment of the present disclosure learns, based on the set of the first learning data to which the first correct answer label, which is the label indicating the correct answer about any one of the plurality of conditions, and the second correct answer label, which is the correct answer label indicating the predetermined state, are given, the generation model for outputting, when the data to which the second correct answer label is given is input, the data to which the first correct answer label indicating any one of the plurality of conditions is given. The learning data generation device according to the embodiment of the present disclosure generates, based on the set of the second learning data, which is the learning data collected under the predetermined condition among the plurality of conditions and is the learning data to which the second correct answer label is given, and the learned generation model, the set of the third learning data to which the first correct answer label and the second correct answer label about the conditions other than the predetermined condition are given. Accordingly, the learning data generation device according to the embodiment of the present disclosure can generate, at low cost, learning data for accurately estimating a state.

<Configuration of the Learning Device According to the Embodiment of the Technique of the Present Disclosure>

An example of the embodiment of the technique of the disclosure is explained below with reference to the drawings. Note that, in the drawings, the same or equivalent components and portions are denoted by the same reference numerals and signs. Dimension ratios of the drawings are exaggerated for convenience of explanation and are sometimes different from actual ratios.

FIG. 1 is a block diagram illustrating a hardware configuration of the learning device 20 according to this embodiment. The hardware configuration of the learning device 20 is the same as the hardware configuration of the learning data generation device 10. Therefore, explanation of the hardware configuration is omitted.

Subsequently, functional components of the learning device 20 are explained. FIG. 2 is a block diagram showing an example of the functional components of the learning device 20.

As shown in FIG. 2, the learning device 20 includes, as the functional components, a pre-learning-estimation-model storage unit 201, a second learning unit 202, and a learned-estimation-model storage unit 203. The functional components are realized by the CPU 11 reading out the learning program stored in the ROM 12 or the storage 14, developing the learning program in the RAM 13, and executing the learning program.

In the pre-learning-estimation-model storage unit 201, an estimation model for estimating a predetermined state about input data is stored in a state before learning, that is, a state in which parameters are initial values. The estimation model can adopt any neural network. For example, the estimation model can adopt an autoencoder.

The second learning unit 202 learns, based on the set of the second learning data and the set of the third learning data generated by the learning data generation device 10, an estimation model for outputting the second correct answer label for input data as an estimation result.

Specifically, first, the second learning unit 202 acquires, from the learning data generation device 10, the set of the combined learning data generated by the learning data generation device 10. The second learning unit 202 acquires the estimation model and the initial parameters from the pre-learning-estimation-model storage unit 201. Subsequently, the second learning unit 202 learns the parameters of the estimation model such that, about each of the set of the combined learning data, an estimation result obtained by inputting the combined learning data to the estimation model coincides with the second correct answer label given to the combined learning data. The second learning unit 202 performs learning of the parameters using, for example, backpropagation. The second learning unit 202 repeats the learning of the parameters until the end condition is satisfied. Note that, in second and subsequent learning, the second learning unit 202 uses parameters learned last time by the second learning unit 202 rather than the initial parameters. The second learning unit 202 stores the learned estimation model and the parameters in the learned-estimation-model storage unit 203.

The estimation model and the parameters learned by the second learning unit 202 are stored in the learned-estimation-model storage unit 203.

The learned estimation model and the learned parameters are used when an estimation device (not shown), which estimates a state of a road surface, estimates the state of the road surface from input road surface data. By using the estimation model and the parameters learned by the learning device 20, the estimation device can accurately estimate the state of the road surface.

<Action of the Learning Device According to the Embodiment of the Technique of the Present Disclosure>

Subsequently, action of the learning device 20 is explained.

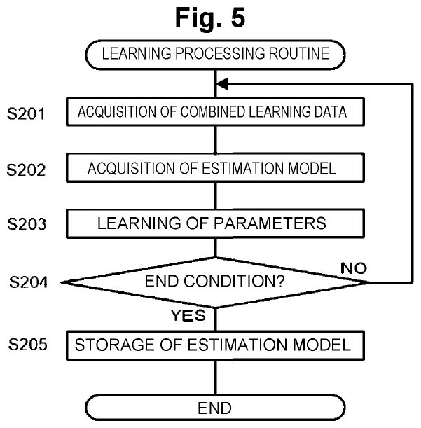

FIG. 5 is a flowchart showing a flow of a learning processing routine by the learning device 20. The CPU 11 reads out the learning data generation program from the ROM 12 or the storage 14, develops the learning data generation program in the RAM 13, and executes the learning data generation program, whereby the learning processing routine is performed.

In step S201, the CPU 11 functions as the second learning unit 202 and acquires, from the learning data generation device 10, the set of the combined learning data generated by the learning data generation device 10.

In step S202, the CPU 11 functions as the second learning unit 202 and acquires, from the pre-learning-estimation-model storage unit 201, about input data, the estimation model and the initial parameters for estimating a predetermined state.

In step S203, the CPU 11 functions as the second learning unit 202 and learns the parameters of the estimation model such that, about each of the set of the combined learning data, an estimation result obtained by inputting the combined learning data to the estimation model coincides with the second correct answer label given to the combined learning data.

In step S204, the CPU 11 functions as the second learning unit 202 and determines whether the end condition is satisfied.

When the end condition is not satisfied (NO in step S204), the CPU 11 returns to step S201.

On the other hand, when the end condition is satisfied (YES in step S204), in step S205, the CPU 11 functions as the second learning unit 202, stores the learned estimation model and the learned parameters in the learned-estimation-model storage unit 203, and ends the processing.

As explained above, the learning device according to the embodiment of the present disclosure learns, based on the set of the second learning data and the set of the third learning data generated by the learning data generation device, about the input data, an estimation model for estimating a predetermined state. Accordingly, the learning device according to the embodiment of the present disclosure can learn an estimation model for accurately estimating a state.

Note that the present disclosure is not limited to the embodiment explained above. Various modifications and applications are possible within a range not departing from the gist of the present invention.

For example, in the embodiment explained above, the learning data generation device and the learning device are explained as separate devices but may be configured as one device.

Note that various processors other than the CPU may execute the learning data generation program executed by the CPU reading the software (the program) in the embodiment. As the processors in this case, a PLD (Programmable Logic Device), a circuit configuration of which can be changed after manufacturing, such as an FPGA (Field-Programmable Gate Array), a dedicated electric circuit, which is a processor including a circuit configuration exclusively designed in order to execute specific processing such as an ASIC (Application Specific Integrated Circuit), and the like are illustrated. The learning data generation program may be executed by one of these various processors or may be executed by a combination of two or more processors of the same type or different types (for example, a combination of a plurality of FPGAs and a combination of a CPU and an FPGA). Hardware structure of these various types of processors is more specifically an electric circuit obtained by combining circuit elements such as semiconductor elements.

In the embodiment, a mode in which each of the learning data generation program and the learning program is stored (installed) in advance in the ROM 12 or the storage 14 has been explained, but this is not restrictive. The programs may be provided in a form in which the programs are stored in non-transitory storage media such as a CD-ROM (Compact Disk Read Only Memory), a DVD-ROM (Digital Versatile Disk Read Only Memory), and a USB (Universal Serial Bus) memory. The programs may be downloaded from an external device via a network.

Concerning the embodiment explained above, the following notes are further disclosed.

### (Note 1)

A learning data generation device comprising:

a memory; and

at least one processor connected to the memory,

the processor being configured to:

learn a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and

generate, based on a set of second learning data and the generation model learned by the first learning unit, a set of third learning data to which the first correct answer label and the second correct answer label about conditions other than the predetermined condition are given, the second learning data being learning data which is collected under a predetermined condition among the plurality of conditions and to which the second correct answer label is given.

### (Note 2)

A non-transitory storage medium storing a learning data generation program for causing a computer to execute:

learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and

generating, based on a set of second learning data and the generation model learned by the first learning unit, a set of third learning data to which the first correct answer label and the second correct answer label about conditions other than the predetermined condition are given, the second learning data being learning data which is collected under a predetermined condition among the plurality of conditions and to which the second correct answer label is given.

### REFERENCE SIGNS LIST

10 learning data generation device
11 CPU
12 ROM
13 RAM
14 storage
15 input unit
16 display unit
17 communication interface
19 bus
20 learning device
101 data storage unit
102 pre-learning-generation-model storage unit
103 learning unit
104 generation-model storage unit
105 data storage unit
106 generation unit
107 data storage unit
108 combination unit
109 learning-data storage unit
201 pre-learning-estimation-model storage unit
202 learning unit
203 estimation-model storage unit

1. A learning data generation device comprising circuitry configured to execute a method comprising:
learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and
generating, based on a set of second learning data and the learned generation model, a set of third learning data to which the first correct answer label and the second correct answer label about conditions other than the predetermined condition are given, the second learning data being learning data which is collected under a predetermined condition among the plurality of conditions and to which the second correct answer label is given.

2. The learning data generation device according to claim 1, wherein
the set of the first learning data and the set of the second learning data include road surface data indicating a state of a road surface, the road surface data being measured by a sensor mounted on a mobile body moving on the road surface,
the predetermined condition is such a condition that the measurement is conducted on a smooth road surface, and
the predetermined state is a state indicating what kind of a barrier the road surface is.

3. The learning data generation device according to claim 1, the circuitry further configured to execute a method comprising:
learning, based on the set of the second learning data and the set of the third learning data, estimation model for estimating the predetermined state.

4. A computer-implemented method for generating learning data, comprising:
learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and
generating, based on a set of second learning data and the learned generation model, a set of third learning data to which the first correct answer label and the second correct answer label about conditions other than the predetermined condition are given, the second learning data being learning data which is collected under a predetermined condition among the plurality of conditions and to which the second correct answer label is given.

5. A computer-readable non-transitory recording medium storing computer-executable program instructions that when executed by a processor cause a computer system to execute a method for generating learning data comprising:
learning a generation model based on a set of first learning data to which a first correct answer label and a second correct answer label are given, the first correct answer label indicating a correct answer about any one of a plurality of conditions, the second correct answer label indicating a predetermined state, the generation model outputting, when data to which the second correct answer label is given is input, data to which the first correct answer label indicating any one of the plurality of conditions is given; and
generating, based on a set of second learning data and the learned generation model, a set of third learning data to which the first correct answer label and the second correct answer label about conditions other than the predetermined condition are given, the second learning data being learning data which is collected under a predetermined condition among the plurality of conditions and to which the second correct answer label is given.

6. The computer-implemented method according to claim 4, wherein
the set of the first learning data and the set of the second learning data include road surface data indicating a state of a road surface, the road surface data being measured by a sensor mounted on a mobile body moving on the road surface,
the predetermined condition is such a condition that the measurement is conducted on a smooth road surface, and
the predetermined state is a state indicating what kind of a barrier the road surface is.

7. The computer-implemented method according to claim 4, the method further comprising:
learning, based on the set of the second learning data and the set of the third learning data, estimation model for estimating the predetermined state.

8. The computer-readable non-transitory recording medium according to claim 5, wherein
the set of the first learning data and the set of the second learning data include road surface data indicating a state of a road surface, the road surface data being measured by a sensor mounted on a mobile body moving on the road surface,
the predetermined condition is such a condition that the measurement is conducted on a smooth road surface, and
the predetermined state is a state indicating what kind of a barrier the road surface is.

9. The computer-readable non-transitory recording medium according to claim 5, the computer-executable program instructions when executed further causing the system to execute a method comprising:
learning, based on the set of the second learning data and the set of the third learning data, estimation model for estimating the predetermined state.
